(19) United States
(12) Patent Application Publication
(10) Pub. No.: US 2019/0244773 A1
(43) Pub. Date: Aug. 8, 2019

(54) NOVEL KEYBOARD STRUCTURE

(71) Applicant: Jiangsu Transimage Technology Co., Ltd., Gaoyou (CN)

(72) Inventors: Weimin Zou, Gaoyou (CN); Qing Zhang, Gaoyou (CN)

(21) Appl. No.: 16/016,572

(22) Filed: Jun. 23, 2018

(30) Foreign Application Priority Data
Feb. 2, 2018 (CN) 201810127518X

(51) Int. Cl. H01H 13/83; H01H 13/705

(52) U.S. Cl. CPC H01H 13/83; H01H 13/88; H01H 13/705

(57) ABSTRACT

A novel keyboard structure includes a base board, scissor-switches, elastic bodies, and keycaps, wherein a circuit is arranged on the base board; when one keycap is depressed, the corresponding elastic body is compressed by the keycap to move in a direction toward the base board, and when a conducting column of the elastic body touches the circuit on the base board, the circuit is connected; after the keycap is released, the keycap moves in a direction away from the base board under the resilient effect of the elastic body, consequently, the conducting column leaves the base board, and the circuit is disconnected.

### TECHNICAL FIELD

The present invention relates to a keyboard structure, and in particular to a novel keyboard structure.

### BACKGROUND ART

The conventional keyboard structure comprises a supporting board and a conductive circuit board at the bottom. If it is a backlight keyboard structure, a backlight module also has to be arranged, as a result, the whole keyboard is thick, many kinds of materials are used, the manufacturing process is complex, and the manufacturing cost is relatively high.

### SUMMARY OF THE INVENTION

### Objective of the Invention

The present invention is intended to provide a keyboard structure which is structurally simple, light and thin and has a simplified process.

### Technical Solution

A novel keyboard structure of the present invention comprises a base board, scissor-switches, elastic bodies, and keycaps, wherein a circuit is arranged on the base board; when one keycap is depressed, the corresponding elastic body is compressed by the keycap to move in a direction toward the base board, and when a conducting column of the elastic body touches the circuit on the base board, the circuit is connected; after the keycap is released, the keycap moves in a direction away from the base board under the resilient effect of the elastic body, consequently, the conducting column leaves the base board, and the circuit is disconnected.

After LED lamps are arranged on the base board, the LEDs emit light to provide a light source, and thus a backlight keyboard structure is formed.

Preferably, the base board is provided with scissor-switch-fixing holes, and the scissor-switch-fixing holes may be through holes or stepped holes.

The bottoms of the scissor-switches are fixed in the scissor-switch-fixing holes by fixing parts, preferably the fixing parts are plastic parts, and at this point, the plastic parts can be injected by an injection molding process to be fixed and formed in the scissor-switch-fixing holes; or the bottoms of the plastic parts can also be provided with heat stakes, and the heat stakes are fixed in the scissor-switch-fixing holes by a heat staking process.

The base board of the present utility model may be a PCB, wherein the PCB is also called a printed circuit board, or a metal plate, a PC board (i.e. polycarbonate board) or a fiberglass board can also be chosen. In addition, the elastic body is preferably a silica gel or metal elastic piece.

### Beneficial Effects

Compared with the prior art, the present invention proposes a brand new keyboard structure, which uses the base board to substitute for the supporting board and the conductive circuit board in the conventional structure, moreover, the backlight module is abandoned, instead the light-emitting diodes are directly arranged on the base board, consequently, the overall thickness of the keyboard becomes smaller, material varieties are reduced, material management is facilitated, the manufacturing process is simplified, and the keyboard cost is reduced.

### BRIEF DESCRIPTION OF THE DRAWINGS

FIG. 1 is a structural schematic diagram of a first keyboard structure;

FIG. 2 is a structural schematic diagram of a second keyboard structure;

FIG. 3 is a structural schematic diagram of a third keyboard structure;

FIG. 4 is a structural schematic diagram of a fourth keyboard structure;

FIG. 5 is a schematic diagram of a keyboard structure provided with light-emitting diodes; and

FIG. 6 is an exploded diagram of a key structure.

### DETAILED DESCRIPTION OF THE INVENTION

The technical solution of the present invention will be further described below with reference to the drawings.

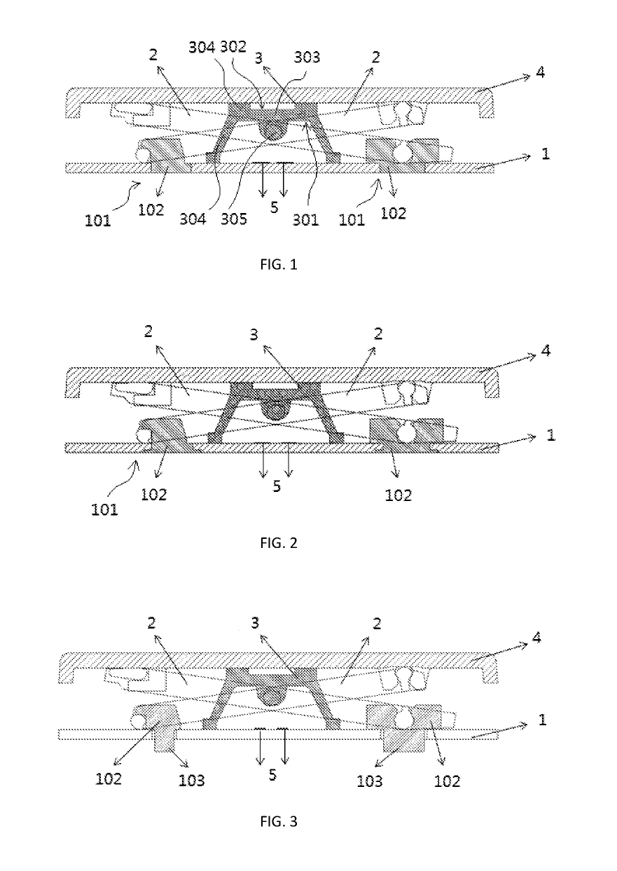

A keyboard structure of the present invention comprises a base board 1, scissor-switches 2, elastic bodies 3, and keycaps 4. As shown in FIG. 6, the base board 1 is a PCB (i.e. printed circuit board), or a metal plate, a PC board or a fiberglass board can also be chosen; each scissor-switch 2 comprises an outer cross arm 201 and an inner cross arm 202 which cross each other, wherein each of the outer cross arm 201 and the inner cross arm 202 is of a square frame structure, and they are fixed between the base board 1 and the keycap 4. The bottom of each keycap 4 is provided with slots, and the tops of the outer cross arm 201 and the inner cross arm 202 are fastened in the slots. The base board 1 is provided with scissor-switch-fixing holes 101, the scissor-switch-fixing holes 101 may be through holes, as shown in FIG. 1 and FIG. 3, or stepped holes, as shown in FIG. 2 and FIG. 4. The bottoms of the outer cross arm 201 and the inner cross arm 202 are fixed in the scissor-switch-fixing holes 101 by fixing parts 102, and plastic parts are chosen as the fixing parts 102. At this point, two types of fixing modes can be used; in the first type of fixing mode, the plastic parts are injected by an injection molding process to be fixed and formed in the scissor-switch-fixing holes 101; in the second type of fixing mode, the bottoms of the plastic parts are provided with heat stakes 103, and the heat stakes 103 are fixed in the scissor-switch-fixing holes 101 by a heat staking process, as shown in FIGS. 3-4.

The elastic bodies 3 of the present invention may be silica gel or metal elastic pieces, each elastic body 3 comprises a lower support 301 and an upper support 302 which are respectively connected to the base board and the keycap, wherein the upper support and the lower support are of concave structures, the concave structure comprises a horizontal portion 303 and supporting legs 304 on both sides, the horizontal portions 303 of the upper support and the lower support are connected together, the supporting legs 304 of the upper support 302 extend upward to be fixed on the bottom of the keycap 4, and the supporting legs 304 of the lower supports 301 extend downward to be fixed on the base board. A conducting column 305 is fixed on the bottom of the horizontal portion 303 of the lower support 301, suspended over the base board 1, and will not be in contact with the base board 1 normally. After the keycap is depressed, the conducting column 305 moves in a direction toward the base board, and connect a circuit on the base board by touching the circuit.

The present invention arranges the circuit 5 on the base board by a process such as etching or printing, and positive electrode and negative electrode contacts of the circuit are arranged at positions on the base board which correspond to the conducting columns 305 of the elastic bodies 3. When one conducting column 305 is in contact with the positive electrode and negative electrode contacts, the circuit is connected, and when the conducting column 305 leaves the positive electrode and negative electrode contacts, the circuit is disconnected.

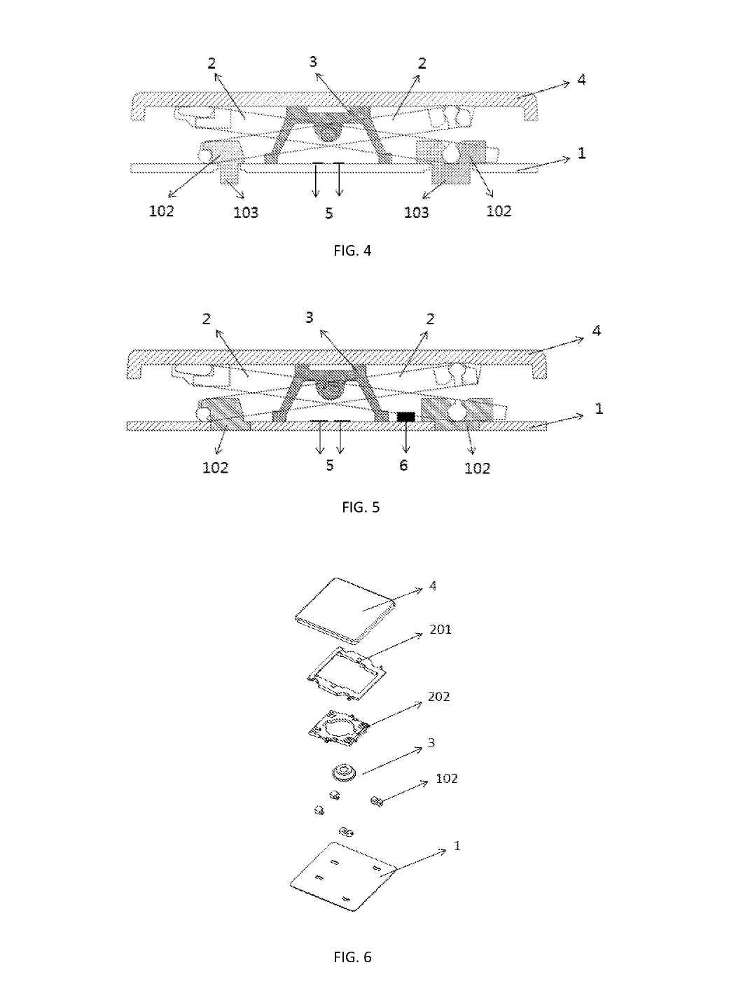

In addition, the present invention may solder light-emitting diodes 6 (i.e. LED lamps) on the base board 1, the number and positions of the placed lamps can be determined according to actual condition, the LEDs can emit light to provide a light source, and thus a backlight keyboard structure is formed, as shown in FIG. 5.

Operating process: When one keycap is depressed, the corresponding elastic body is compressed by the keycap to move in a direction toward the base board, and when a conducting column of the elastic body touches the circuit on the base board, the circuit is connected; after the keycap is released, the keycap moves in a direction away from the base board under the resilient effect of the elastic body, consequently, the conducting column leaves the base board, and the circuit is disconnected.

1. A novel keyboard structure, wherein comprising a base board, scissor-switches, elastic bodies, and keycaps, wherein a circuit is arranged on the base board; when one keycap is depressed, the corresponding elastic body is compressed by the keycap to move in a direction toward the base board, and when a conducting column of the elastic body touches the circuit on the base board, the circuit is connected; after the keycap is released, the keycap moves in a direction away from the base board under the resilient effect of the elastic body, consequently, the conducting column leaves the base board, and the circuit is disconnected.

2. The novel keyboard structure according to claim 1, wherein light-emitting diodes are arranged on the base board.

3. The novel keyboard structure according to claim 1, wherein the base board is provided with scissor-switch-fixing holes, and bottoms of the scissor-switches are fixed in the scissor-switch-fixing holes by fixing parts.

4. The novel keyboard structure according to claim 3, wherein the fixing parts are plastic parts.

5. The novel keyboard structure according to claim 4, wherein the plastic parts are injected in the scissor-switch-fixing holes by an injection molding process.

6. The novel keyboard structure according to claim 4, wherein the bottom of each plastic part is provided with a heat stake, and the heat stake is fixed in the scissor-switch-fixing hole by a heat staking process.

7. The novel keyboard structure according to claim 3, wherein the scissor-switch-fixing holes are through holes or stepped holes.

8. The novel keyboard structure according to claim 1, wherein the base board is a PCB, a metal plate, a PC board or a fiberglass board.

9. The novel keyboard structure according to claim 1, wherein the elastic bodies are silica gel or metal elastic pieces.
